(19) United States
(12) Patent Application Publication
(10) Pub. No.: US 2025/0147502 A1
(43) Pub. Date: May 8, 2025

(54) DIAGNOSIS SYSTEM, DIAGNOSIS METHOD, AND PROGRAM

(71) Applicant: Panasonic Intellectual Property Management Co., Ltd., Osaka (JP)

(72) Inventors: TORU TAZAWA, Osaka (JP); YUSUKE KUBOI, Osaka (JP); YUTA SHIRAKI, Osaka (JP); KOICHI KUSUKAME, Nara (JP)

(21) Appl. No.: 18/712,303

(22) PCT Filed: Oct. 26, 2022
(86) PCT No.: PCT/JP2022/039857

§ 371 Date: Nov. 1, 2024

(30) Foreign Application Priority Data
Dec. 1, 2021 (JP) 2021-195620

(51) Int. Cl. G05B 23/02

(52) U.S. Cl. CPC G05B 23/0283; G05B 23/0227

(57) ABSTRACT

An object is to make it easy to intuitively understand a state of a drive system. Diagnosis system (1) diagnoses a specific state related to performance of drive system (A1) including mechanical mechanism (M1) driven by motor (62). Diagnosis system (1) includes first acquisition part (11), second acquisition part (12), arithmetic part (21), and output processor (22). First acquisition part (11) acquires specification information (D1) related to a specification of mechanical mechanism (M1). Second acquisition part (12) acquires actual measurement information (D2) related to a mechanical characteristic of mechanical mechanism (M1). Arithmetic part (21) calculates an index value associated with the specific state based on specification information (D1) and actual measurement information (D2). Output processor (22) outputs the index value in a mode in which the user can identify the specific state.

### TECHNICAL FIELD

The present disclosure generally relates to a diagnosis system, a diagnosis method, and a program. More specifically, the present disclosure relates to a diagnosis system, a diagnosis method, and a program for diagnosing a state related to performance of a drive system including a mechanical mechanism driven by a motor.

### BACKGROUND ART

In a servomotor control device described in PTL 1, a motor controller drives and controls a servomotor, and transmits power of the servomotor to a table (driven body) via a coupling mechanism (drive system). The servomotor control device includes a force acquisition part and a rigidity estimation part. The force acquisition part acquires the driving force acting on the driven body at a junction between the coupling mechanism and the driven body. The rigidity estimation part estimates the magnitude of the rigidity of the coupling mechanism based on the position information of the servomotor and the driving force acquired by the force acquisition part when the servomotor is rotated in a state where the driven body is mechanically fixed. The servomotor control device detects deterioration of the coupling mechanism and displays information indicating the deterioration on a display part when the estimated rigidity decreases to have a value less than or equal to a threshold.

### CITATION LIST

### Patent Literature

PTL 1: Unexamined Japanese Patent Publication No. 2018-152990

### SUMMARY OF THE INVENTION

However, there are various types (abnormal noise, vibration, reduction in accuracy, and the like) of events that may occur due to deterioration of the drive system. In the servomotor control device described in PTL 1, since only the magnitude of the rigidity of the coupling mechanism (drive system) is estimated, the user may have difficulty in intuitively understanding the relationship between the magnitude of the rigidity of the coupling mechanism and the degree of deterioration of the coupling mechanism. That is, even when the magnitude of the rigidity simply becomes less than or equal to the threshold and the deterioration of the coupling mechanism is notified, it may be difficult to make sense to the user.

The present disclosure has been made in view of the above circumstances, and an object of the present disclosure is to provide a diagnosis system, a diagnosis method, and a program that make it easy to intuitively understand a state of a drive system.

A diagnosis system according to one aspect of the present disclosure diagnoses a specific state related to performance of a drive system including a mechanical mechanism driven by a motor. this diagnosis system includes a first acquisition part, a second acquisition part, an arithmetic part, and an output processor. The first acquisition part acquires specification information related to a specification of the mechanical mechanism. The second acquisition part acquires actual measurement information related to a mechanical characteristic of the mechanical mechanism. The arithmetic part calculates an index value associated with the specific state based on the specification information and the actual measurement information. The output processor outputs the index value in a mode in which a user can identify the specific state.

A diagnosis method according to one aspect of the present disclosure diagnoses a specific state related to performance of a drive system that is a mechanical mechanism driven by a motor and includes the mechanical mechanism. The diagnosis method includes a first acquisition processing step, a second acquisition processing step, an arithmetic processing step, and an output processing step. In the first acquisition processing step, specification information related to the specification of the mechanical mechanism is acquired. In the second acquisition processing step, actual measurement information related to the mechanical characteristic of the mechanical mechanism is acquired. In the arithmetic processing step, an index value associated with the specific state is calculated based on the specification information and the actual measurement information. In the output processing step, the index value is output in a mode in which the specific state can be identified.

A program according to one aspect of the present disclosure is a program for causing one or more processors to execute the diagnosis method described above.

The present disclosure has an advantage that the state of the drive system can be easily and intuitively understood.

### BRIEF DESCRIPTION OF THE DRAWINGS

FIG. 1 is a schematic block configuration diagram of an entire system including a diagnosis system according to an exemplary embodiment.

FIG. 2 is a Bode plot of an open loop for describing a gain margin and a phase margin in a diagnosis system according to an exemplary embodiment.

FIG. 3 is a schematic diagram in which a control target is modeled in a two-inertia system in order to describe calculation of a spring constant in a diagnosis system according to an exemplary embodiment.

FIG. 4 is a graph related to a change in a target value of a motor position for describing a measurement of stoppage torque in a diagnosis system according to an exemplary embodiment.

FIG. 5 is a graph of a speed-friction characteristic for describing a measurement of stoppage torque in a diagnosis system according to an exemplary embodiment.

FIG. 6A is a conceptual diagram of a control target for describing a measurement of stoppage torque in a diagnosis system according to an exemplary embodiment.

FIG. 6B is a conceptual diagram of a control target for describing a measurement of stoppage torque in a diagnosis system according to an exemplary embodiment.

FIG. 7A is a graph related to a control stability index (index value) output from a diagnosis system according to an exemplary embodiment.

FIG. 7B is a graph related to an accuracy reduction amount (index value) output from a diagnosis system according to an exemplary embodiment.

FIG. 7C is a graph using a control margin (index value) as a control stability index output from a diagnosis system according to an exemplary embodiment.

FIG. 8 is a conceptual diagram of meter display of an index value in a diagnosis system according to an exemplary embodiment.

FIG. 9 is a graph for describing a remaining life width output from a diagnosis system according to an exemplary embodiment.

FIG. 10 is a flowchart for describing an operation in a diagnosis system according to an exemplary embodiment.

### DESCRIPTION OF EMBODIMENT

### (Overview)

Hereinafter, a diagnosis system, a diagnosis method, and a program according to exemplary embodiments will be described with reference to the drawings.

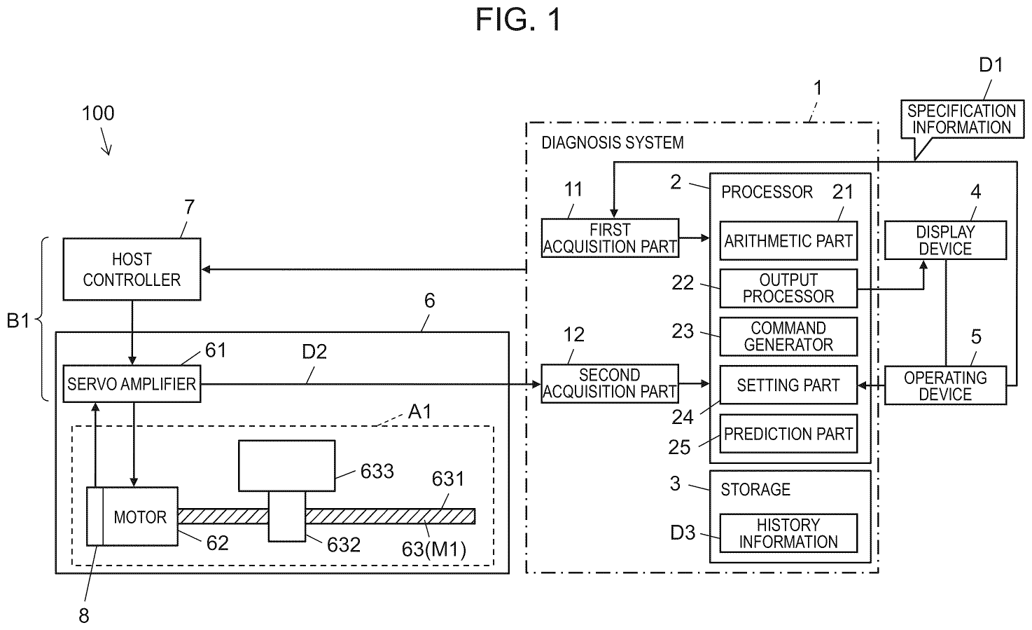

FIG. 1 is a schematic block configuration diagram of an entire system including a diagnosis system according to the exemplary embodiment. As illustrated in FIG. 1, diagnosis system 1 according to one aspect is configured to diagnose a specific state (for example, a deterioration state) related to performance of drive system A1 (control target) including mechanical mechanism M1 driven by motor 62 (servomotor). Motor 62 (servomotor) is a rotary motor. Mechanical mechanism M1 is not particularly limited, and is, for example, a ball screw mechanism, a gear mechanism, a belt mechanism, or the like. In the present exemplary embodiment, a case where mechanical mechanism M1 is ball screw mechanism 63 (see FIG. 1) will be described as an example. The mechanical mechanism represents a structure that acts with a machine operation. For example, as described below, ball screw mechanism 63 represents a mechanism including screw shaft 631 that rotates, nut 632 that linearly moves along screw shaft 631 with rotation of screw shaft 631, and a ball that couples screw shaft 631 and nut 632. The drive system represents a system including a motor, a mechanical mechanism driven by the motor, and a structure operated with the operation of the mechanical mechanism. For example, as described below, drive system A1 represents a system including motor 62, mechanical mechanism M1 driven by motor 62, and movable portion 633 operated with the operation of mechanical mechanism M1.

As illustrated in FIG. 1, diagnosis system 1 includes first acquisition part 11, second acquisition part 12, arithmetic part 21, and output processor 22.

First acquisition part 11 acquires specification information D1 (for example, a specification value of a lead or the like) related to the specification of mechanical mechanism M1. Second acquisition part 12 acquires actual measurement information D2 related to the a mechanical characteristic of mechanical mechanism M1. Arithmetic part 21 calculates an index value associated with a specific state (for example, a deterioration state) based on specification information D1 and actual measurement information D2. Output processor 22 outputs the index value in a mode in which the user can identify the specific state.

According to diagnosis system 1 described above, the index value calculated based on specification information D1 and actual measurement information D2 is output in a mode in which the user can identify the specific state. Thus, the user of diagnosis system 1 can easily and intuitively understand the state of drive system A1. The “user” referred to in the present disclosure may be, for example, a person who manages or monitors a specific work (for example, conveyance work) process using servo system 6 (see FIG. 1) in a facility such as a factory, or a person who performs maintenance of servo system 6.

A diagnosis method according to one aspect diagnoses a specific state related to performance of drive system A1 including mechanical mechanism M1 driven by motor 62. The diagnosis method includes a first acquisition processing step, a second acquisition processing step, an arithmetic processing step, and an output processing step. In the first acquisition processing step, specification information D1 related to the specification of mechanical mechanism M1 is acquired. In the second acquisition processing step, actual measurement information D2 related to the mechanical characteristic of mechanical mechanism M1 is acquired. In the arithmetic processing step, the index value associated with the specific state is calculated based on specification information D1 and actual measurement information D2. In the output processing step, the index value is output in a mode in which the user can identify the specific state. The above-described diagnosis method has an advantage that the user can easily and intuitively understand the state of drive system A1.

This diagnosis method is used on a computer system (diagnosis system 1). That is, this diagnosis method can also be embodied by a program. A program according to one aspect is a program for causing one or more processors to execute the diagnosis method described above. The program may be recorded in a non-transitory computer-readable recording medium.

### (Details)

### (1) Overall Configuration

Hereinafter, the entire system (integrated system 100) including diagnosis system 1 according to the present exemplary embodiment and a peripheral configuration of the system will be described in detail with reference to FIGS. 1 to 10. As illustrated in FIG. 1, the peripheral configuration of integrated system 100 includes display device 4, operating device 5, servo system 6, host controller 7, and position detector 8. At least a part of the peripheral configuration may be included in the configuration of diagnosis system 1.

Diagnosis system 1 obtains an index value using two types of information (specification information D1 and actual measurement information D2), and diagnoses a state of servo system 6, in particular, a specific state related to performance of drive system A1 including mechanical mechanism M1 driven by motor 62 in servo system 6. In the present exemplary embodiment, as an example, it is assumed that the “specific state related to performance” of drive system A1 is a deterioration state of drive system A1 that progresses with time. However, the “specific state related to performance” of drive system A1 may be, for example, an anomaly state caused by mixing of foreign matter into drive system A1 or the like in addition to the deterioration state.

As an example, diagnosis system 1 outputs the index value in a mode in which the user can identify whether drive system A1 corresponds to a relatively good state (good), a sign state with a sign of failure (sign), or a state in which a failure has occurred (defect). When drive system A1 is identified as being in a defective state, the user is recommended to newly replace a part or all of drive system A1 (for example, all of mechanical mechanism M1).

Display device 4 includes a liquid crystal display or an organic electro-luminescence (EL) display. Display device 4 performs display corresponding to various types of information acquired from diagnosis system 1. In particular, display device 4 displays (presents) a diagnosis result.

Operating device 5 includes, for example, one or more of a mouse, a keyboard, a pointing device, and the like. Operating device 5 is used together with display device 4. The user operates operating device 5 to input information while referring to the information displayed on display device 4. The user can input specification information D1 or perform setting related to the degradation diagnosis (for example, setting of an execution timing or an execution frequency of a predetermined test operation to be described later) by operating device 5. Appropriately performing the setting via operating device 5 makes it possible to improve the accuracy of the degradation diagnosis of diagnosis system 1.

Operating device 5 may be formed integrally with display device 4. For example, a touch pad of operating device 5 and a display of display device 4 may constitute a touch panel. Display device 4 may be a display part of a mobile terminal such as a notebook computer, a tablet terminal, or a smartphone.

Although diagnosis system 1 is illustrated outside servo amplifier 61 in FIG. 1, the function of diagnosis system 1 is assumed to be implemented in servo amplifier 61, for example. The function of diagnosis system 1 may be mounted on a stationary personal computer installed in a facility (factory or the like) in which servo system 6 is installed, a server device, or the like. Alternatively, diagnosis system 1 may be provided at a place away from the facility.

Position detector 8, host controller 7, display device 4, and operating device 5 are installed, for example, in a facility where servo system 6 is installed.

Diagnosis system 1 can communicate with each of position detector 8, host controller 7, display device 4, operating device 5, and the like, which are peripheral configurations, in a wired or wireless manner via a local network constructed in the facility. When the function of diagnosis system 1 is provided outside servo amplifier 61, diagnosis system 1 can communicate with servo amplifier 61 in a wired or wireless manner via a local network. Diagnosis system 1 may be communicable with at least some of the peripheral configurations via a wide area network such as the Internet.

### (2) Servo System

Servo system 6 is used, for example, for executing a predetermined work in a manufacturing process of a product (which may be a semi-product). As illustrated in FIG. 1, servo system 6 includes servo amplifier 61, motor 62 (servomotor), and mechanical mechanism M1. As described above, mechanical mechanism M1 is, for example, ball screw mechanism 63. In the present exemplary embodiment, motor 62 and mechanical mechanism M1 (ball screw mechanism 63) driven by motor 62 constitute drive system A1 (control target), and diagnosis system 1 is used to diagnose a deterioration state of drive system A1. In other words, diagnosis system 1 is used for deterioration diagnosis of at least either motor 62 or mechanical mechanism M1 (here, mechanical mechanism M1).

As described above, motor 62 is a rotary motor. Motor 62 has an output shaft, and rotates the output shaft under the control of servo amplifier 61. Mechanical mechanism M1 is coupled to the output shaft of motor 62. Mechanical mechanism M1 is powered by motor 62.

Ball screw mechanism 63, which is mechanical mechanism M1, is a mechanism that converts linear motion into rotational motion or converts rotational motion into linear motion. In the present exemplary embodiment, ball screw mechanism 63 is used in a mode of performing rotational motion by receiving power of motor 62 and converting the rotational motion into linear motion. Specifically, as illustrated in FIG. 1, ball screw mechanism 63 includes screw shaft 631 that rotates by receiving power of motor 62, and nut 632 that is coupled (screwed) to screw shaft 631 via a ball (steel ball) and linearly moves along screw shaft 631 with rotation of screw shaft 631. For example, movable portion 633 (load) such as a stage or an arm for conveyance is fixed to nut 632, and a product or a component held by movable portion 633 can be sequentially conveyed along screw shaft 631 when servo system 6 is in operation.

When the deterioration of servo system 6, in particular, the deterioration of mechanical mechanism M1 progresses with time, for example, the characteristics of control system B1 (see FIG. 1) change, the stability of the control decreases, and abnormal noise or oscillation may occur. Here, control system B1 represents a system that controls the operation of drive system A1. In the present exemplary embodiment, as an example, host controller 7 and servo amplifier 61 constitute control system B1, but only either host controller 7 or servo amplifier 61 may constitute control system B1.

In addition, when the deterioration of mechanical mechanism M1 progresses with time, even though abnormal noise or oscillation does not occur, a problem such as a reduction in operation accuracy of mechanical mechanism M1 may occur. For example, in ball screw mechanism 63, the preload decreases (so-called preload release) due to wear of the groove of screw shaft 631, the groove of nut 632, and the like, and the positioning accuracy of nut 632 may decrease.

When diagnosis system 1 performs a deterioration diagnosis of mechanical mechanism M1, the user can be notified of the presence or absence of the failure of mechanical mechanism M1 or the degree of deterioration.

Diagnosis system 1 may perform the deterioration diagnosis while servo system 6 is executing predetermined work (for example, conveyance work of products or parts) (that is, during operation). However, in the present exemplary embodiment, diagnosis system 1 performs the deterioration diagnosis by stopping the predetermined work and causing servo system 6 to execute a predetermined test operation. The test operation will be described later.

### (3) Position Detector

Position detector 8 includes an encoder and the like, and detects the position (speed information) of motor 62 in servo system 6. Position detector 8 outputs a detection signal (electric signal) including a detection value to servo amplifier 61. Based on the detection signal and a first control signal (operation control signal) from host controller 7, servo amplifier 61 controls the operation of motor 62 so as to execute the operation of a predetermined work (for example, conveyance work). Based on the detection signal and a second control signal (test control signal) from host controller 7, servo amplifier 61 controls the operation of motor 62 so as to execute a predetermined test operation of mechanical mechanism M1. In the present exemplary embodiment, position detector 8 may also directly output the detection signal to diagnosis system 1.

### (4) Host Controller and Servo Amplifier

Host controller 7 outputs the first control signal or the second control signal to servo amplifier 61. This causes host controller 7 to control the operation of servo system 6. Each of the first control signal and the second control signal includes data and the like for designating the position and operation of movable portion 633 (load). Servo amplifier 61 determines a control value of drive system A1 according to each control signal and the detection signal from position detector 8. The control value includes, for example, a command value of the rotation speed of motor 62, a command value of the rotation angle, and a torque command value. Servo amplifier 61 includes a power convertor, and adjusts the power supplied to motor 62 based on the determined control value, thereby controlling the operation of motor 62. The control signal (for example, the second control signal for the test) may be directly transmitted from diagnosis system 1 to servo amplifier 61. In particular, when the function of diagnosis system 1 is mounted in servo amplifier 61, servo amplifier 61 can control the operation of motor 62 without receiving a command of host controller 7 when executing the test operation. In short, when the function of diagnosis system 1 is used, host controller 7 may be omitted.

Servo amplifier 61 outputs actual measurement information D2 related to the measured mechanical characteristic of mechanical mechanism M1 to diagnosis system 1 in the test operation (see FIG. 1). Host controller 7 may output at least a part of actual measurement information D2 to diagnosis system 1. Position detector 8 may output at least a part of actual measurement information D2 to diagnosis system 1.

Actual measurement information D2 is used to calculate an index value in diagnosis system 1. As an example, actual measurement information D2 includes input information and output information for calculating the frequency characteristic of an open loop. The input information includes information related to a command value (hereinafter, it may be simply referred to as a “torque command value”) of the torque of motor 62. The output information includes information related to the rotation speed (hereinafter, it may be simply referred to as “motor speed”) of motor 62. The motor speed is obtained by differentiating a detection value of position detector 8 that detects the rotation angle (position) of motor 62. The motor speed may be indirectly obtained from a detection value of a sensor that detects a rotational speed or a rotational angle (position) of screw shaft 631 of ball screw mechanism 63.

Actual measurement information D2 includes information related to the torque (hereinafter, it may be simply referred to as “stoppage torque”) applied to nut 632 when the rotation of screw shaft 631 is stopped in the test operation. In the present exemplary embodiment, it is assumed that the torque command value that is a command value of the torque of motor 62 is used as the stoppage torque.

### (5) Diagnosis System

### (5.1) Constituent Elements

Diagnosis system 1 includes a computer system including one or more processors and memories. At least part of the function of diagnosis system 1 is implemented by the processor of the computer system executing a program recorded in the memory of the computer system. The program may be recorded in the memory, may be provided through a telecommunication line such as the Internet, or may be recorded in a non-transitory recording medium such as a memory card.

As illustrated in FIG. 1, diagnosis system 1 includes first acquisition part 11, second acquisition part 12, processor 2, and storage 3. First acquisition part 11, second acquisition part 12, and processor 2 merely indicate functions implemented by one or more processors, and do not necessarily indicate substantial configurations.

### (5.2) First Acquisition Part and Second Acquisition Part

First acquisition part 11 and second acquisition part 12 each acquire information for diagnosis. For example, diagnosis system 1 further includes a communication interface device, and each of first acquisition part 11 and second acquisition part 12 acquires information for diagnosis via a communication interface device.

First acquisition part 11 is configured to acquire specification information D1 related to the specification of mechanical mechanism M1. In the present exemplary embodiment, since mechanical mechanism M1 is ball screw mechanism 63, as an example, specification information D1 preferably includes at least information related to a lead (distance that nut 632 advances in axial direction with one rotation of screw shaft 631), a screw shaft outer diameter, and a screw total length. Specification information D1 preferably includes information indicating whether or not ball screw mechanism 63 is of a preloaded type. Specification information D1 may include information of specification values such as a screw root diameter, a dimensional table rigidity value, bearing rigidity, a ball center diameter, a basic dynamic rated load, an initial preload (in the case of a preloaded type), and a total inertia of mechanical mechanism M1.

For example, first acquisition part 11 acquires an input value input by an external operation (user operation) to operating device 5 as specification information D1. First acquisition part 11 may acquire (download) specification information D1 from a server that manages various mechanical mechanisms M1 via a network such as the Internet. The timing at which first acquisition part 11 acquires specification information D1 is not particularly limited, but is preferably acquired before execution of the first test operation and the second test operation. Acquired specification information D1 is input to processor 2. Acquired specification information D1 is contained (stored) in storage 3.

Second acquisition part 12 acquires actual measurement information D2 related to the a mechanical characteristic of mechanical mechanism M1. Actual measurement information D2 includes input information (torque command value) and output information (motor speed) for measuring the frequency characteristic of an open loop at the time of the first test operation. Actual measurement information D2 includes information on the torque (torque command value) applied to nut 632 during the second test operation. The information on the torque command value also includes information on the stoppage torque.

During the first test operation, second acquisition part 12 acquires input information (torque command value) and output information (motor speed) from the controller of servo amplifier 61 as actual measurement information D2 in real time, for example. During the second test operation, second acquisition part 12 acquires a torque command value of motor 62 corresponding to the torque applied to nut 632 from the controller of servo amplifier 61 as actual measurement information D2 in real time, for example. Acquired actual measurement information D2 is input to processor 2. Acquired actual measurement information D2 is contained (stored) in storage 3.

In short, second acquisition part 12 acquires a test result (for example, the torque command value, the motor speed, and the torque applied to nut 632) obtained in a predetermined test operation (the first test operation or the second test operation) as actual measurement information D2.

### (5.3) Storage

Examples of storage 3 are a read only memory (ROM), a random access memory (RAM), or an electrically erasable programmable read only memory (EEPROM). As described later, storage 3 can store history information D3 (see FIG. 1) related to the index value.

### (5.4) Processor

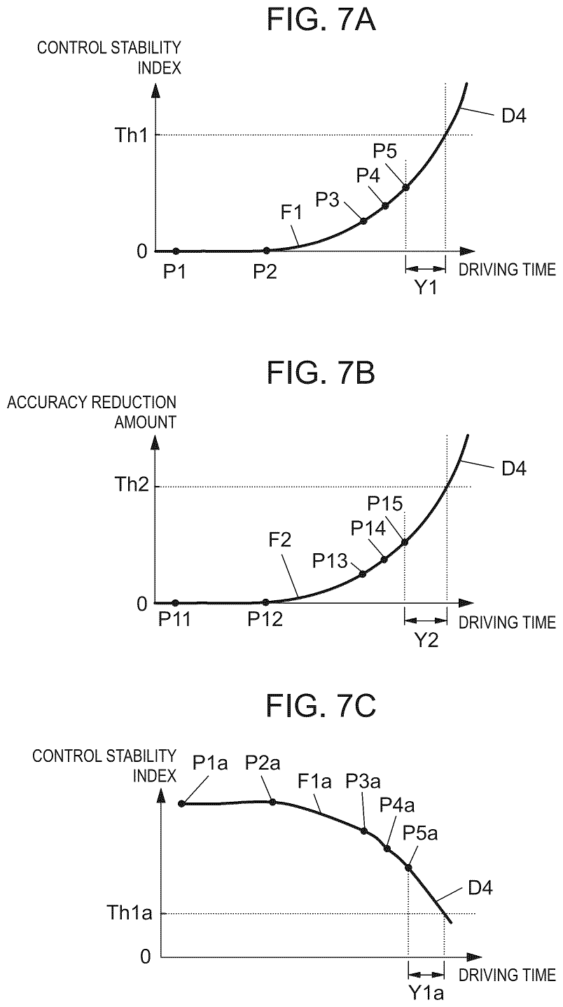

Processor 2 includes arithmetic part 21, output processor 22, command generator 23, setting part 24, and prediction part 25. Arithmetic part 21 calculates, based on specification information D1 and actual measurement information D2, an index value associated with a specific state (for example, a deterioration state) related to performance of drive system A1 that is a control target. In the present exemplary embodiment, it is assumed that arithmetic part 21 calculates two types of an index value (hereinafter, it may be referred to as a “control stability index (value)” (see FIGS. 7A and 7C to be described later)) related to the stability of control system B1 and an index value (hereinafter, it may be referred to as an “accuracy reduction amount” (see FIG. 7B to be described later)) related to the stability of the operation position of drive system A1. The index value may be, for example, an estimated value related to an abnormal sound level emitted from drive system A1 other than the above-described two types.

However, it is not essential for arithmetic part 21 to calculate both the control stability index and the accuracy reduction amount, and only one of them may be calculated. In other words, the “index value” in the present disclosure indicates at least either the control stability (stability of control system B1) that changes according to the performance change of drive system A1 or the stability of the operation position of drive system A1 that changes according to the performance change of drive system A1.

To calculate the control stability index (value), arithmetic part 21 first measures the frequency characteristic using actual measurement information D2 (torque command value and motor speed). For example, arithmetic part 21 calculates (measures) the frequency characteristic by performing frequency analysis (Fast Fourier Transform (FFT)) on each of the time-series data of the torque command value and the time-series data of the motor speed and obtaining a difference between them.

Command generator 23 generates an operation command for causing drive system A1 to execute a predetermined test operation (first test operation or second test operation). Command generator 23 uses a part or all of specification information D1 acquired by first acquisition part 11 to create the operation instruction. In addition, command generator 23 may use information stored in advance in storage 3 for creating the operation instruction.

Command generator 23 generates an instruction signal (electric signal) including information designating a “target value” such as a position, a speed, and a torque of motor 62 so as to cause movable portion 633 (load) to perform a reciprocating motion a predetermined number of times, for example, as the operation instruction for the second test operation, and transmits the instruction signal to host controller 7. In the present exemplary embodiment, the second test operation is a minute distance moving operation of moving a distance shorter than the distance of movable portion 633 (load) during operation. Host controller 7 generates the second control signal based on the received command signal and outputs the second control signal to servo amplifier 61. Command generator 23 may directly output the command signal as the second control signal to servo amplifier 61 without using host controller 7. Servo amplifier 61 performs feedback control using the detection signal from position detector 8 with reference to the second control signal, determines a control value including the torque command value and the like, and controls the operation of motor 62. As a result, the second test operation is executed. Servo amplifier 61 transmits the torque command value, which is one of the control values determined during the test operation, to second acquisition part 12.

Regarding the first test operation, a method for measuring the frequency characteristic is not particularly limited. Command generator 23 may generate a command signal including all the frequency components as the operation command for the first test operation, and give the command signal to the control target (measurement using white noise). Command generator 23 may also generate a command signal having a waveform in which the frequency changes with time as the operation command for the first test operation, and apply the command signal to the control target (measurement using sinusoidal sweep). Alternatively, command generator 23 may generate a command signal having a waveform obtained by combining a plurality of sine waves within a predetermined frequency range as the operation command for the first test operation, and give the command signal to the control target (measurement using multisine).

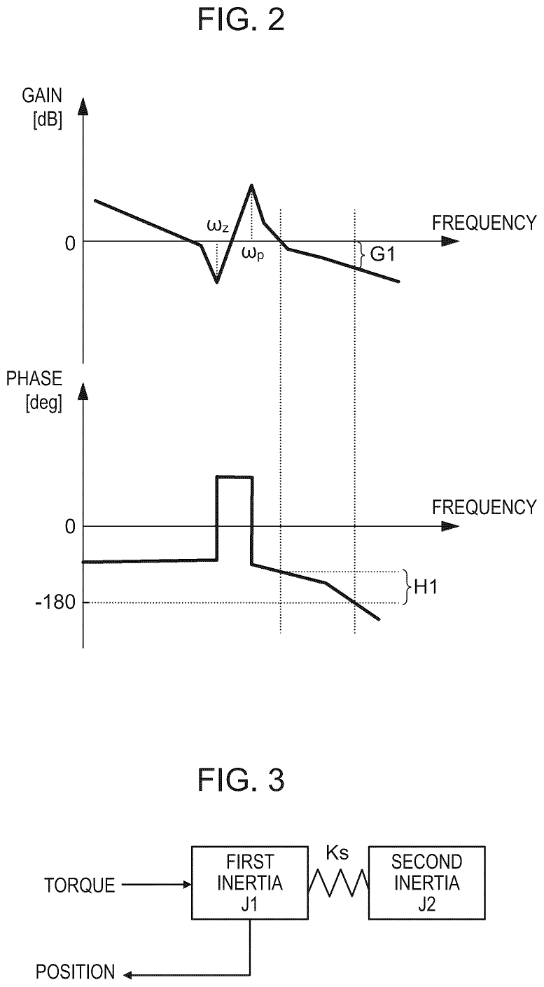

FIG. 2 is a Bode plot of an open loop for describing a gain margin and a phase margin in diagnosis system 1 according to the present exemplary embodiment. The control stability can be determined from gain margin G1 (the difference between the gain when the phase is −180° and 0 dB) or phase margin H1 (the difference between the phase when the gain is 0 dB and −180°) of Bode plot (see FIG. 2) of the open loop with the input as the torque command value and the output as the motor speed. For example, when gain margin G1 is 12 dB to 20 dB, it can be said that the control stability is good. For example, when phase margin H1 is 40° to 60°, it can be said that the control stability is good. The frequency characteristic may be a closed-loop frequency characteristic as a control characteristic of the feedback control.

As a predetermined test operation, diagnosis system 1 measures frequency characteristics in a first test operation (for example, a test operation using white noise) and measures stoppage torque in a second test operation (for example, a test operation by a reciprocating motion). Hereinafter, when the first test operation and the second test operation are not distinguished for the sake of description, they may be simply referred to as a test operation.

In the present exemplary embodiment, it is assumed that the first test operation and the second test operation are executed at different timings, but the first test operation and the second test operation may be one continuous test operation.

Arithmetic part 21 obtains the control margin such as gain margin G1 (see FIG. 2), phase margin H1 (see FIG. 2), or the gain peak from the frequency characteristic measured in the first test operation, and calculates the control stability index (see FIG. 7A) based on the control margin. The control stability index may be a control margin or a value obtained by substituting the control margin into a predetermined arithmetic expression. For example, the control stability index may be calculated as a percentage (%), or may be calculated as a control stability level indicated in a plurality of stages such as level 1 to level 5.

In the present exemplary embodiment, as the control stability index is closer to 0 (zero), the stability is better, and gradually increases as deterioration progresses with time. When the control stability index becomes equal to or more than threshold Th1 which is a measure of stability set based on the control theory, drive system A1 (control target) is determined to be failed (defective state). That is, the control stability index (index value) can be said to be a value associated with the deterioration state of drive system A1. Threshold Th1 may be a set value set by the user via operating device 5. When the control margin is directly used as the control stability index without using a predetermined arithmetic expression, the control stability index gradually decreases as the deterioration progresses as illustrated in FIG. 7C. When it becomes equal to or less than threshold Th1a, which is a measure of stability, drive system A1 is determined to be failed (defective state). Threshold Th1a may be a set value set by the user via operating device 5.

In addition, arithmetic part 21 obtains spring constant Ks (see FIG. 3) of mechanical mechanism M1 in order to calculate the accuracy reduction amount. In other words, arithmetic part 21 calculates the accuracy reduction amount using specification information D1, actual measurement information D2, and spring constant Ks. In the present exemplary embodiment, spring constant Ks is obtained using the frequency characteristics measured in the first test operation as described above.

Hereinafter, spring constant Ks will be described with reference to FIG. 3. FIG. 3 is a schematic diagram in which a control target is modeled in a two-inertia system in order to describe calculation of spring constant Ks in diagnosis system 1 according to the exemplary embodiment. More specifically, FIG. 3 is a schematic diagram in which drive system A1 that is a control target is modeled in a two-inertia system. It is assumed that first inertia J1 includes motor 62, screw shaft 631 of ball screw mechanism 63, and the like. It is assumed that second inertia J2 includes nut 632 of ball screw mechanism 63, movable portion 633 (load), and the like. Spring constant Ks illustrated in FIG. 3 is a spring constant of the spring element when a joint (for example, a joint between screw shaft 631 and nut 632) between first inertia J1 and second inertia J2 is regarded as the spring element. The “torque” illustrated in FIG. 3 is an input value input to first inertia J1, and corresponds to the torque command value in the present exemplary embodiment. The “position” illustrated in FIG. 3 is an output value output from first inertia J1, and corresponds to the motor speed obtained by differentiating the detection value of position detector 8 that detects the rotation angle (position) of motor 62 in the present exemplary embodiment.

The following Formula (1) represents an open-loop transfer function H₁(s) that is a function of complex number s at input/output with an input as the torque command value and an output as the motor speed. J₁ is an inertia moment (inertia) of first inertia J1, ωₚ is a resonance frequency, and ω_{z} is an antiresonance frequency. The following Formula (2) is a modification of Formula (1), and J₂ is an inertia moment (inertia) of second inertia J2. Arithmetic part 21 calculates resonance frequency ωₚ and antiresonance frequency ω_{z} from the measured frequency characteristics (see the Bode plot of FIG. 2).

$$[ Mathematical Formula 1 ]$$

$${H}_{1} ( s ) = \frac{1}{{J}_{1} s} \cdot \frac{{s}^{2} + {ω}_{z}^{2}}{{s}^{2} + {ω}_{p}^{2}} \qquad ( 1 )$$

$$[ Mathematical Formula 2 ]$$

$$\begin{matrix}{H}_{1} ( s ) = \frac{{J}_{2}}{{J}_{1} {J}_{2} s} \cdot \frac{{s}^{2} + {ω}_{z}^{2}}{{s}^{2} + {ω}_{p}^{2}} \\ = \frac{{J}_{2} {s}^{2} + {J}_{2} {ω}_{z}^{2}}{{J}_{1} {J}_{2} {s}^{3} + {J}_{1} {J}_{2} {ω}_{p}^{2} s}\end{matrix} \qquad ( 2 )$$

The following Formula (3) represents an open-loop transfer function H₂(s) that is a function of complex number s at input/output with an input as the torque command value and an output as the motor speed. J₁ is an inertia moment (inertia) of first inertia J1, J₂ is an inertia moment (inertia) of second inertia J2, and Ks is a spring constant. Arithmetic part 21 calculates spring constant Ks from the coefficient comparison between H₁(s) in Deformation Formula (2) and H2 (s) in Formula (3), resonance frequency ωp, antiresonance frequency ω_{z}, and specification information D1.

Specifically, the following Formulas (4) and (5) are obtained by coefficient comparison between Deformation Formula (2) and the following Formula (3). The total inertia (J₁+J₂) of mechanical mechanism M1 may be a value input by the user as specification information D1 or an estimated value estimated by servo system 6. By using the following Formula (6) obtained from Formulas (4) and (5), it is possible to individually obtain inertia J₁ of first inertia J1 and inertia J₂ of second inertia J2 from the total inertia, resonance frequency ωₚ, and antiresonance frequency ω_{z}. As a result, spring constant Ks can be calculated by using Formula (4) or Formula (5).

Since spring constant Ks of ball screw mechanism 63 is calculated from the measured frequency characteristics in this manner, it can be said that actual measurement information D2 includes information related to the frequency characteristics of drive system A1 used to calculate spring constant Ks of ball screw mechanism 63.

$$[ Mathematical Formula 3 ]$$

$${H}_{2} ( s ) = \frac{{J}_{2} {s}^{2} + {K}_{s}}{{J}_{1} {J}_{2} {s}^{3} + {K}_{s} ( {J}_{1} + {J}_{2} ) s} \qquad ( 3 )$$

$$[ Mathematical Formula 4 ]$$

$${K}_{s} = {J}_{2} {ω}_{z}^{2} \qquad ( 4 )$$

$$[ Mathematical Formula 5 ]$$

$${K}_{s} = \frac{{J}_{1} {J}_{2}}{{J}_{1} + {J}_{2}} {ω}_{p}^{2} \qquad ( 5 )$$

$$[ Mathematical Formula 6 ]$$

$$\frac{{J}_{1}}{{J}_{1} + {J}_{2}} = \frac{{ω}_{z}^{2}}{{ω}_{p}^{2}} \qquad ( 6 )$$

Arithmetic part 21 measures the stoppage torque in order to calculate the accuracy reduction amount.

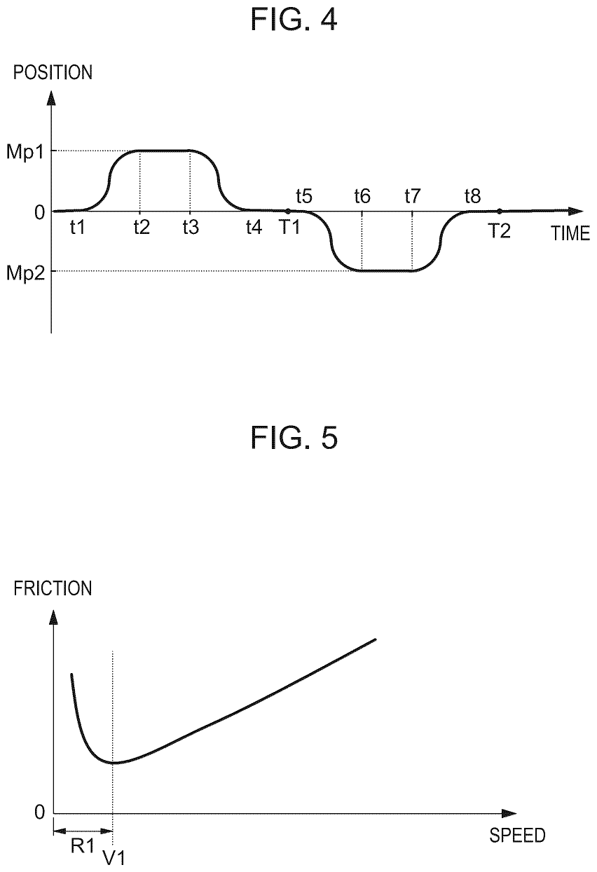

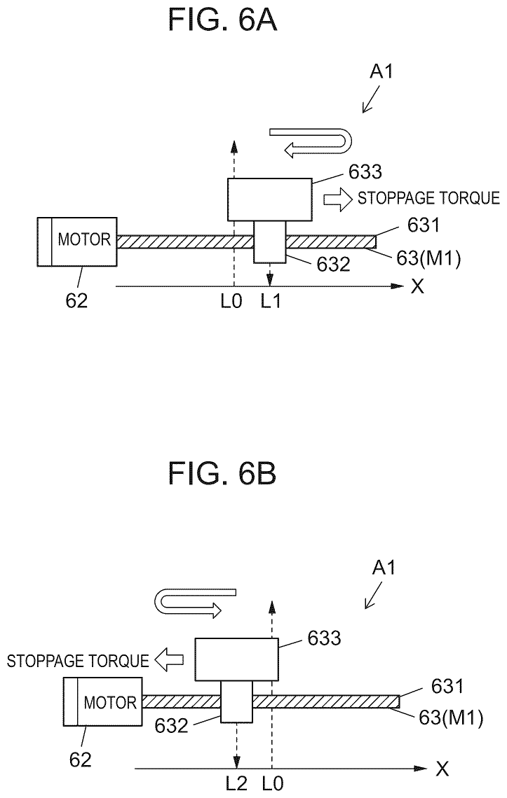

Hereinafter, the measurement of the stoppage torque will be described with reference to FIGS. 4 to 6B. FIG. 4 is a graph related to a change in a target value of the position of motor 62 for describing a measurement of stoppage torque in diagnosis system 1 according to the present exemplary embodiment. FIG. 5 is a graph of a speed-friction characteristic for describing a measurement of stoppage torque in diagnosis system 1 according to the present exemplary embodiment. FIG. 6A is a conceptual diagram of drive system A1 (control target) for describing a measurement of stoppage torque in diagnosis system 1 according to the present exemplary embodiment. FIG. 6B is a conceptual diagram of drive system A1 (control target) for describing a measurement of stoppage torque in diagnosis system 1 according to the present exemplary embodiment.

FIG. 4 illustrates a change in the target value of the motor position with the lapse of time during the second test operation specified by the command signal from command generator 23 when movable portion 633 (load) is caused to execute a reciprocating motion.

FIGS. 6A and 6B each illustrate a conceptual diagram of drive system A1 (control target) that performs a reciprocating motion in response to a command signal during the second test operation. In FIGS. 6A and 6B, an insubstantial X axis (horizontal axis) along the axial direction of screw shaft 631 is illustrated. In FIGS. 6A and 6B, the positive direction of the X axis is a direction in which nut 632 and movable portion 633 are separated from motor 62, and the negative direction of the X axis is a direction in which nut 632 and movable portion 633 approach motor 62.

FIG. 6A illustrates a state in which drive system A1 performs a reciprocating motion with respect to the positive direction of the X axis. FIG. 6B illustrates a state in which drive system A1 performs a reciprocating motion with respect to the negative direction of the X axis. In the present exemplary embodiment, diagnosis system 1 performs two types of reciprocating motions, that is, a reciprocating motion in the positive direction of the X axis and a reciprocating motion in the negative direction of the X axis, as the second test operation, and measures the stoppage torque (torque command value) in each of the two types.

Here, the origin at the center of the X axis indicates position L0 of movable portion 633 (load) corresponding to the target position on the motor basis. That is, in drive system A1 in a state where the deterioration of mechanical mechanism M1 has not progressed (for example, a state where mechanical mechanism M1 is at the time of manufacturing and shipping), when motor 62 stops after one reciprocating motion, movable portion 633 stops at position L0. However, when the deterioration of mechanical mechanism M1 progresses, above-described spring constant Ks changes, and movable portion 633 is likely to stop at a position shifted from target position L0 when motor 62 is stopped. In particular, as the deterioration of mechanical mechanism M1 progresses, the change in spring constant Ks increases, and there is a high possibility that the shift amount also increases. As in the example of FIG. 6A, there is a possibility that movable portion 633 stops at position L1 shifted to the positive side of the X axis from position L0 at the end of the reciprocating motion. As in the example of FIG. 6B, there is also a possibility that movable portion 633 stops at position L2 shifted to the negative side of the X axis from position L0 at the end of the reciprocating motion.

When the motor position in FIG. 4 is a positive position, the motor moves in the positive direction of the X axis in FIGS. 6A and 6B, and when the motor position is a negative position, the motor moves in the negative direction of the X axis. That is, FIG. 4 illustrates a change in the target value of the motor position specified by the command signal from command generator 23 when the reciprocating motion illustrated in FIG. 6A is executed once and then the reciprocating motion illustrated in FIG. 6B is executed once.

More specifically, as illustrated in FIG. 4, motor 62 is instructed to start the forward rotation at time point t1. As a result, movable portion 633 starts to move in the positive direction of the X axis. The time from time point t1 to time point t2 is a time during which motor 62 rotates forward at a constant angular acceleration and decelerates to stop at time point t2 after reaching the maximum speed. That is, motor 62 is instructed to stop at position Mp1 at time point t2. In FIG. 4, the time from time point t2 to time point t3 is a stop time of motor 62. As a result, movable portion 633 temporarily stops at a position farthest from position L0 in the reciprocating motion illustrated in FIG. 6A during the period from time point t2 to time point t3.

Motor 62 is instructed to start reverse rotation at time point t3. The time from time point t3 to time point t4 is a time during which motor 62 reversely rotates at a constant angular acceleration and decelerates to stop at time point t4 after reaching the maximum speed. That is, motor 62 is instructed to stop at the original position at time point t4. Then, one reciprocating motion with respect to the positive direction of the X axis ends. In FIG. 4, the time from time point t4 to time point t5 is a stop time of motor 62. As a result, movable portion 633 temporarily stops between time point t4 and time point t5. At this time, when the deterioration of drive system A1 has not progressed and spring constant Ks is within the normal range, movable portion 633 stops at original position L0.

Thereafter, motor 62 is instructed to start reverse rotation at time point t5, and movable portion 633 starts to move in the negative direction of the X axis. The time from time point t5 to time point t6 is a time during which motor 62 reversely rotates at a constant angular acceleration and decelerates to stop at time point to after reaching the maximum speed. That is, motor 62 is instructed to stop at position Mp2 at time point t6. In FIG. 4, the time from time point t6 to time point t7 is a stop time of motor 62. As a result, movable portion 633 temporarily stops at a position farthest from position L0 in the reciprocating motion illustrated in FIG. 6B during the period from time point t6 to time point t7.

Motor 62 is instructed to start forward rotation at time point t7. The time from time point t7 to time point t8 is a time during which motor 62 rotates forward at a constant angular acceleration and decelerates to stop at time point t8 after reaching the maximum speed. That is, motor 62 is instructed to stop at the original position at time point t8. Then, one reciprocating motion with respect to the negative direction of the X axis ends. At this time, when the deterioration of drive system A1 has not progressed and spring constant Ks is within the normal range, movable portion 633 stops at original position L0.

In the second test operation, diagnosis system 1 of the present exemplary embodiment sets the graph shape of the target value of the motor position (see FIG. 4) such that an overshoot of movable portion 633 does not occur immediately before the stop when movable portion 633 is positioned at the target position. In other words, the test operation includes an operation executed in a speed range in which an overshoot does not occur in drive system A1. That is, diagnosis system 1 sets the graph shape of the target value of the motor position illustrated in FIG. 4 such that the maximum speed when the motor position is viewed with the speed waveform obtained by time-differentiating the motor position falls within the above-described speed range. When an overshoot occurs, although the position deviation of nut 632 due to the progress of the deterioration occurs, the position deviation is offset by the overshoot, and as a result, nut may stop at position L0. When the test operation is performed in the above speed range, the position of nut 632 caused by the progress of the deterioration can be most shifted, and as a result, the degree of progress of the deterioration can be diagnosed more accurately.

Hereinafter, the “speed range in which an overshoot does not occur” in the present disclosure will be described with reference to FIG. 5. FIG. 5 is a graph schematically illustrating friction-velocity characteristics related to mechanical mechanism M1. Horizontal axis in FIG. 5 represents, for example, the magnitude of the speed of movable portion 633 (load), and the vertical axis in FIG. 5 represents, for example, friction (resistance) applied to movable portion 633 (and nut 632). The frictional resistance is generated at a boundary between the surface of the ball (steel ball) and the surface of the groove on screw shaft 631 side in ball screw mechanism 63, a boundary between the surface of the ball (steel ball) and the surface of the groove on nut 632 side, and the like. As illustrated in FIG. 5, the frictional resistance decreases from the start of the movement of movable portion 633 until the speed reaches V1, but increases in proportion to the increase in the speed when the speed becomes V1 or more. In the present disclosure, it is assumed that the “speed range in which an overshoot does not occur” is range R1 (see FIG. 5) in which the magnitude of the speed is larger than 0 (zero) and less than or equal to speed V1 at which the frictional resistance becomes the minimum value.

Command generator 23 determines a target value of the motor position so that the magnitude of the speed of movable portion 633 falls within range R1. Command generator 23 may automatically determine range R1 based on specification information D1. Alternatively, range R1 may be set according to an operation input of the user via operating device 5.

Next, measurement timing of the stoppage torque will be described with reference to FIG. 4. Arithmetic part 21 of the present exemplary embodiment measures torque command values at two timings (hereinafter, referred to as first measurement time point T1 and second measurement time point T2) in one reciprocating motion as the stoppage torque (see FIG. 4).

First measurement time point T1 is set within a stop period (time point t4 to time point t5) in which motor 62 stops in response to the stop command in order to end the reciprocating motion in the positive direction of the X axis. During the stop period, movable portion 633 is theoretically stopped at original position L0. However, there is a possibility that movable portion 633 is not stopped for a short time from time point t4 when the stop command of motor 62 is completed. Thus, first measurement time point T1 is set to a time point at which a predetermined time elapses from time point t4 at which the command to return the motor position to the original position is completed.

Second measurement time point T2 is set after time point t8 at which motor 62 stops in response to the stop command in order to end the reciprocating motion with respect to the negative direction of the X axis. After time point t8, movable portion 633 is theoretically stopped at original position L0. However, there is a possibility that movable portion 633 is not stopped for a short time from time point t8 when the stop command of motor 62 is completed. Thus, similarly to first measurement time point T1, second measurement time point T2 is set to a time point at which a predetermined time elapses from time point t8 at which the command to return the motor position to the original position is completed.

Arithmetic part 21 of the present exemplary embodiment obtains an average value of the stoppage torque measured at first measurement time point T1 and the stoppage torque measured at second measurement time point T2, and uses the obtained average value as a measurement result.

Arithmetic part 21 calculates the maximum shift amount with respect to position L0 of movable portion 633 at the time of positioning using the stoppage torque as the measurement result, calculated spring constant Ks, and specification information D1. Arithmetic part 21 calculates the shift amount from the stoppage torque and spring constant Ks using, for example, the well-known Hooke's law. Then, arithmetic part 21 calculates the accuracy reduction amount (see FIG. 7B) based on the maximum shift amount. When ball screw mechanism 63 is of a preloaded type, arithmetic part 21 performs correction to subtract a preload amount (preload torque) from a stoppage torque, and calculates the maximum shift amount. The preload torque is calculated using specification information D1 such as a lead. The accuracy reduction amount may be a maximum shift amount or a value obtained by substituting the maximum shift amount into a predetermined arithmetic expression. The accuracy reduction amount may be calculated, for example, as a percentage (%), or may be calculated as an accuracy reduction level indicated by a plurality of levels such as level 1 to level 5.

In the present exemplary embodiment, as the accuracy reduction amount is closer to 0 (zero), the accuracy reduction amount is better, and gradually increases as deterioration progresses with time. When the accuracy reduction amount becomes equal to or larger than threshold Th2 set based on specification information D1, drive system A1 (control target) is determined to be failed (defective state). That is, the accuracy reduction amount (index value) can be said to be a value associated with the deterioration state of drive system A1. Threshold Th2 may be a set value set by a user via operating device 5.

Output processor 22 outputs the index value in a mode in which the user can identify the specific state. In the present exemplary embodiment, as an example, it is assumed that the “mode” in which the user can identify the specific state is a mode in which the specific state can be visually identified. Output processor 22 generates information (hereinafter, it may be referred to as “diagnosis result information”) for causing display device 4 to display the index value on the screen, and transmits the information to display device 4. The diagnosis result information includes the index value (numerical value) itself, and the index value (numerical value) may also be displayed on display device 4.

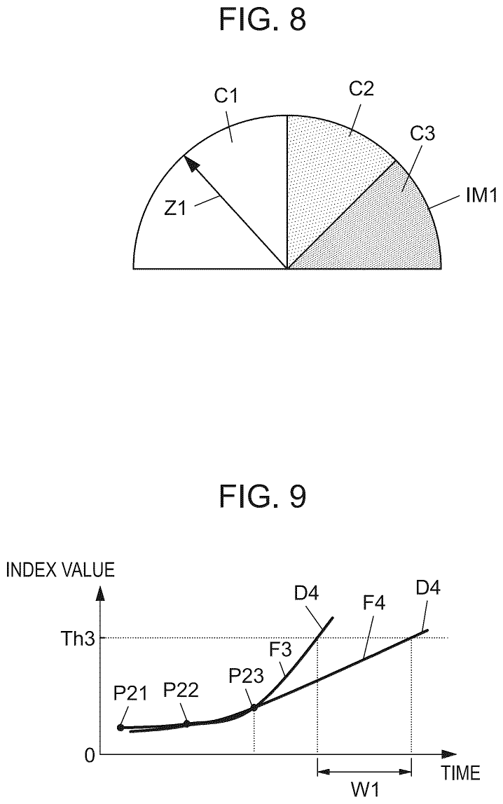

FIG. 8 is a conceptual diagram of meter display of an index value in diagnosis system 1 according to the present exemplary embodiment. The diagnosis result information is output to display device 4 with meter display, for example. Specifically, as illustrated in FIG. 8, the diagnosis result information includes information for causing display device 4 to display semicircular image IM1 including three regions of good region C1, sign region C2, and defective region C3 on the screen. Good region C1 is a region indicating that the state of drive system A1 is “good”. Sign region C2 is a region indicating that deterioration progresses and a “sign” of a failure is observed. Defective region C3 is a region indicating that the state of drive system A1 is “defective” such that replacement of parts or the like of drive system A1 is recommended promptly. The diagnosis result information includes information for displaying the image of needle Z1 corresponding to the current index value on the screen by superimposing the image on image IM1. From the position of needle Z1, the user can visually recognize where the current index value is located in the three regions, and can easily and intuitively understand the state of drive system A1.

In the present exemplary embodiment, since arithmetic part 21 calculates both the control stability index and the accuracy reduction amount as index values, output processor 22 generates both the diagnosis result information for the control stability index and the diagnosis result information for the accuracy reduction amount. As a result, display device 4 performs two types of meter display of the control stability index and the accuracy reduction amount. However, only either the control stability index or the accuracy reduction amount may be indicated by a meter.

The diagnosis result information may be output to display device 4 with color display. That is, the current index value may be presented by a difference in color (for example, blue color for good, orange color for sign, and red color for defective) displayed on display device 4. The color display may be applied in combination with the meter display. In FIG. 8, good region C1 may be displayed in blue, sign region C2 may be displayed in orange, and defective region C3 may be displayed in red.

In addition, the diagnosis result information may be output to display device 4 with icon display. For example, the current index value may be presented by a difference (for example, a smile for good, a sad face for sign, and a cry face for defective) in icons imitating a person's face. The icon display may be applied in combination with the color display.

Alternatively, the “mode” in which the user can identify the specific state may be a mode in which the user can aurally identify the specific state. Output processor 22 generates voice information (diagnosis result information) for causing an output device such as a speaker to output the index value, and transmits the voice information to the output device. When the output device is attached to display device 4, the voice information is transmitted to display device 4. The voice information includes, for example, a voice message (or an alarm sound) indicating any of good, sign, and defect. These voice messages are stored in storage 3 in advance. Since the diagnosis result information is output by sound, the user can intuitively understand the state of drive system A1. The diagnosis result information may be provided to the user by both the meter display or the icon display and the sound output.

In short, the “mode” in which the user can identify the specific state preferably includes at least one of output of the index value with sound, output of the index value with meter display, output of the index value with color display, and output of the index value with icon display.

Setting part 24 performs a setting related to an execution timing or an execution frequency of the test operation (the first test operation or the second test operation) according to an operation input from the outside. For example, diagnosis system 1 displays a setting screen on display device 4 when receiving an operation input for requesting setting related to the execution timing or the execution frequency via operating device 5. The user inputs, for example, information (setting information) for specifying a desired execution timing (as an example, 17:00 at which the operation on the operating day ends) using operating device 5 while referring to the setting screen. Setting part 24 contains the setting information in storage 3. Diagnosis system 1 starts execution of the test operation at the execution timing based on the setting information. Providing setting part 24 makes it possible to easily reflect the user's request regarding the execution timing or the execution frequency of the test operation and improve the convenience. In particular, the diagnosis can be performed at a timing that does not place a burden on the operation.

Further, as illustrated in FIGS. 7A to 7C, diagnosis system 1 of the present exemplary embodiment is configured to present transition information D4 to the user via display device 4.

Specifically, storage 3 stores (contains) history information D3 related to the calculated index value. That is, storage 3 contains the calculated index value as history information D3 together with the driving time every time the test operation is performed. Output processor 22 displays the history of the change in the index value based on history information D3. As an example, output processor 22 transmits transition information D4 to display device 4 so as to display the information from display device 4, and causes display device 4 to display the change in the index value in the history.

Prediction part 25 generates transition information D4 indicating the transition of the index value with the lapse of time based on the index value calculated based on actual measurement information D2 obtained in the latest measurement and history information D3 stored in storage 3.

FIG. 7A is a graph related to a control stability index (index value) output from diagnosis system 1 according to the present exemplary embodiment. FIG. 7B is a graph related to an accuracy reduction amount (index value) output from diagnosis system 1 according to the present exemplary embodiment. FIG. 7C is a graph using a control margin (index value) as a control stability index output from diagnosis system 1 according to the present exemplary embodiment. More specifically, FIG. 7A illustrates a graph of transition information D4 related to the control stability index (an index value obtained by substituting the control margin into a predetermined arithmetic expression). FIG. 7B illustrates a graph of transition information D4 related to the accuracy reduction amount. FIG. 7C illustrates a graph of transition information D4 related to the control stability index (control margin). Each of horizontal axes in FIGS. 7A to 7C represents the driving time after drive system A1 is newly introduced into the facility. FIGS. 7A and 7B illustrate a state in which each index value increases (deteriorates) as the driving time passes. FIG. 7C illustrates a state in which the index value decreases (deteriorates) as the driving time passes. Transition information D4 in FIGS. 7A to 7C also includes a history related to index values calculated in the past.

In FIG. 7A, plots P1 to P4 indicate the past control stability index (history information D3) stored in storage 3, and plot P5 indicates the control stability index calculated based on actual measurement information D2 obtained in the most recent (for example, the current) measurement. In FIG. 7B, plots P11 to P14 indicate the past accuracy reduction amount (history information D3) stored in storage 3, and plot P15 indicates the accuracy reduction amount calculated based on actual measurement information D2 obtained in the most recent (for example, the current) measurement. Plot P1 and plot P11 are index values obtained by the test operation at the same execution timing. Similarly, plot P2 and plot P12, plot P3 and plot P13, plot P4 and plot P14, and plot P5 and plot P15 are index values obtained by the test operation at the same execution timing. In FIG. 7C, plots P1a to P4a indicate the past control margin (history information D3) stored in storage 3, and plot P5a indicates the control margin calculated based on actual measurement information D2 obtained in the most recent (for example, the current) measurement. Plot P1 and plot P1a are index values obtained by the test operation at the same execution timing. Similarly, plot P2 and plot P2a, plot P3 and plot P3a, plot P4 and plot P4a, and plot P5 and plot P5a are index values obtained by the test operation at the same execution timing.

Prediction part 25 obtains an approximate curve (F1, F2, F1a) from a plurality of plots (P1 to P5, or P11 to P15, or P1a to P5a) relating to the current index value and the past index value using, for example, the least squares method, and generates transition information D4. Output processor 22 presents generated transition information D4 from display device 4. Transition information D4 being presented to the user makes it possible for the user to more accurately grasp the deterioration change of drive system A1. That is, the user can more easily understand the state of drive system A1.

Transition information D4 may be displayed in different colors such as a plot (P1 to P5, or P11 to P15, or P1a to P5a), an approximate curve (F1, F2, F1a), and a background according to a state (good, sign, defective) corresponding to each of the current index value and the past index value. In addition, transition information D4 may be displayed by changing color shading between the current index value and the past index value so that the time series can be recognized.

Further, prediction part 25 predicts the failure timing of drive system A1 based on generated transition information D4. In the present exemplary embodiment, as an example, as illustrated in FIGS. 7A to 7C, prediction part 25 estimates a remaining life time (Y1, Y2, Y1a) from the current point of time as the failure timing of drive system A1. That is, prediction part 25 predicts the remaining life time (Y1, Y2, Y1a) based on the approximate curve (F1, F2, F1a) generated by output processor 22 and the threshold (Th1, Th2, Th1a). Specifically, for the control stability index, prediction part 25 obtains remaining life time Y1 until reaching threshold Th1 on approximate curve F1 from current plot P5 as illustrated in FIG. 7A. With respect to the accuracy reduction amount, prediction part 25 obtains remaining life time Y2 until reaching threshold Th2 on approximate curve F2 from current plot P15 as illustrated in FIG. 7B. When the control margin is used as it is as the control stability index, as illustrated in FIG. 7C, prediction part 25 obtains remaining time Y1a until reaching threshold Th1a on approximate curve F1a from current plot P5a.

Output processor 22 outputs the prediction result (remaining life time Y1, Y2, Y1a) of prediction part 25. In the present exemplary embodiment, as an example, output processor 22 causes display device 4 to display a screen including the prediction result of prediction part 25 as transition information D4. Output processor 22 may preferentially display, from display device 4, transition information D4 including the shorter one of remaining life time Y1 (or Y1a) based on the control stability index and remaining life time Y2 based on the accuracy reduction amount. Further, output processor 22 may compare the remaining life time of the shorter time with the predetermined time, and display a warning message to the user when the remaining life time is less than the predetermined time. Further, output processor 22 may notify the user of a difference (remaining life width) between the remaining life time Y1 (or Y1a) and the remaining life time Y2. Output processor 22 preferably notifies the user of an execution timing (for example, a time shorter than the remaining life time) at which execution of the test operation is recommended next time based on the predicted remaining life time.

Since diagnosis system 1 has the function of prediction part 25, the user can be notified of the failure timing of drive system A1 in advance.

FIG. 9 is a graph for describing a remaining life width output from diagnosis system 1 according to the present exemplary embodiment. Specifically, FIG. 9 illustrates a graph of transition information D4 related to a certain index value (may be a control stability index, an accuracy reduction amount, or another index value). FIG. 9 illustrates approximate curve F3 obtained using the least squares method and approximate curve F4 obtained using a method different from the least squares method (for example, the maximum likelihood method) from two plots P21 and P22 of the past index values and plot P23 of the most recent (current) index value. As illustrated in FIG. 9, when the past index value data is small, there is a possibility that a difference (remaining life width W1) is generated in the remaining life time estimated with respect to threshold Th3 due to the difference in the method of obtaining the approximate curve. As illustrated in FIG. 9, output processor 22 preferably displays a plurality of graphs of transition information D4 obtained by a plurality of methods and notifies the user of remaining life width W1.

Depending on the difference in the type of the index value (control stability indicator, accuracy reduction amount, or another indicator value), the cycle of sampling the data of the index value (daily, weekly, monthly, etc.) may be different. The remaining life width may also occur in the remaining life time estimated from different index values. It is preferable that output processor 22 notify the user of a remaining life width due to a difference in sampling period.

### (6) Deterioration Diagnosis

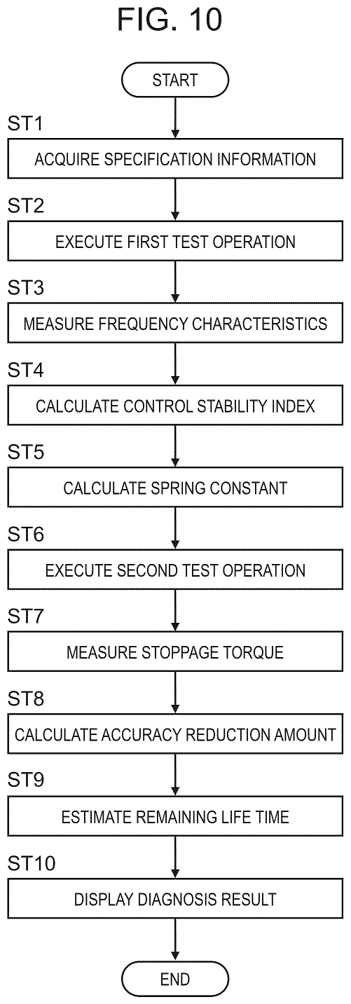

Hereinafter, a series of flow of degradation diagnosis using diagnosis system 1 will be described with reference to FIG. 10. FIG. 10 is a flowchart for describing an operation in diagnosis system 1 according to the present exemplary embodiment. The flowchart illustrated in FIG. 10 is merely an example of the flow of the deterioration diagnosis according to the present disclosure, and an order of kinds of processing may be appropriately changed, or the processing may be appropriately added or omitted.

In diagnosis system 1, first acquisition part 11 acquires specification information D1 related to the specification of ball screw mechanism 63 such as the lead via operating device 5 (step ST1). In other words, the diagnosis method in the present disclosure includes a first acquisition processing step of acquiring specification information D1.

Diagnosis system 1 executes the first test operation (step ST2), and second acquisition part 12 acquires the torque command value and the motor speed (actual measurement information D2). In other words, the diagnosis method according to the present disclosure includes a second acquisition processing step of acquiring actual measurement information D2.

In diagnosis system 1, arithmetic part 21 measures the frequency characteristic using the torque command value and the motor speed acquired during the first test operation (step ST3). Diagnosis system 1 obtains the control margin from the measured frequency characteristics, and calculates the control stability index based on the control margin (step ST4). In other words, the diagnosis method according to the present disclosure includes a calculation processing step of calculating an index value (control stability index). In diagnosis system 1, arithmetic part 21 calculates spring constant Ks from the frequency characteristics and the like (step ST5).

Next, diagnosis system 1 executes the second test operation (step ST6), and arithmetic part 21 measures the stoppage torque during the second test operation (step ST7). Then, in diagnosis system 1, arithmetic part 21 calculates the maximum shift amount with respect to position L0 of movable portion 633 at the time of positioning using spring constant Ks, the stoppage torque, and specification information D1, and calculates the accuracy reduction amount based on the maximum shift amount (step ST8). In other words, the diagnosis method according to the present disclosure includes an arithmetic processing step of calculating an index value (accuracy reduction amount).

Further, in diagnosis system 1, prediction part 25 estimates the remaining life time of drive system A1 from transition information D4 generated using past history information D3 (step ST9).

In diagnosis system 1, output processor 22 displays the diagnosis result (control stability indicator, accuracy reduction amount, remaining life time, and the like) on the screen from display device 4 in meter display and in graph form (step ST10). In other words, the diagnosis method in the present disclosure includes an output processing step of outputting the index value in a mode in which the user can identify the specific state. The diagnosis result is contained in storage 3 and used as a part of history information D3 at the time of the next deterioration diagnosis.

In this manner, according to diagnosis system 1, the index value calculated based on specification information D1 and actual measurement information D2 is output in a mode in which the user can identify the specific state. Thus, the user of diagnosis system 1 can easily and intuitively understand the state of drive system A1.

### (7) Variations

The above exemplary embodiment is merely one of various exemplary embodiments of the present disclosure. The above exemplary embodiment can be variously changed in accordance with design and the like as long as the object of the present disclosure can be achieved. In addition, functions similar to those of diagnosis system 1 according to the above-described exemplary embodiment may be embodied by a diagnosis method, a computer program, a non-transitory recording medium recording a computer program, or the like.

Modifications of the above-described exemplary embodiment will be listed below. The modifications to be described below can be applied in appropriate combination.

Diagnosis system 1 of the present disclosure includes a computer system. The computer system mainly includes a processor and a memory as hardware. The processor executes a program recorded in the memory of the computer system, thereby implementing a function as diagnosis system 1 in the present disclosure. The program may be recorded in advance in the memory of the computer system, may be provided through a telecommunication line, or may be provided by being recorded in a non-transitory recording medium such as a memory card, an optical disk, or a hard disk drive readable by the computer system. The processor of the computer system includes one or a plurality of electronic circuits including a semiconductor integrated circuit (IC) or a large-scale integration (LSI). The integrated circuit such as an IC or an LSI mentioned here is called differently depending on a degree of integration, and includes integrated circuits called a system LSI, a very large scale integration (VLSI), or an ultra large scale integration (ULSI). Moreover, a field-programmable gate array (FPGA) programmed after manufacture of LSI, and a logical device capable of reconfiguring a joint relationship in LSI or reconfiguring circuit partitions in LSI can also be used as processors. The plurality of electronic circuits may be aggregated in one chip or may be provided in a distributed manner on a plurality of chips. The plurality of chips may be aggregated in one device or may be provided in a distributed manner in a plurality of devices. The computer system mentioned here includes a microcontroller having one or more processors and one or more memories. Therefore, the microcontroller also includes one or a plurality of electronic circuits including a semiconductor integrated circuit or a large-scale integrated circuit.

In addition, integration of a plurality of functions in diagnosis system 1 into one housing is not essential. For example, the components of diagnosis system 1 may be distributed in a plurality of housings.

On the contrary, multiple functions in diagnosis system 1 may be aggregated in one housing. Further, at least some of functions of diagnosis system 1, for example, some functions of diagnosis system 1 may be achieved by a cloud (cloud computing) or the like.

In the exemplary embodiment described above, in addition to position detector 8, for example, a detector such as a current sensor, a torque sensor, a speed sensor, or a position sensor may be provided. The current sensor may detect a current supplied to motor 62. The torque sensor may detect the torque of motor 62. The speed sensor may detect the rotation speed of motor 62. The position sensor may detect the position of mechanical mechanism M1 that moves corresponding to the rotation of motor 62, for example, the position of nut 632 that moves linearly. The position of mechanical mechanism M1 may be detected by a camera.

In the exemplary embodiment described above, diagnosis system 1 uses the torque command value of motor 62 as the stoppage torque. However, for example, a torque sensor for a test that detects the stoppage torque in a test operation may be provided. Specifically, a method may be adopted in which a load cell (torque sensor) is attached to nut 632 side, and a screw is rotated for measurement. Alternatively, a method may be adopted in which screw shaft 631 is rotated to fix nut 632 around, and the torque is measured with the axial force of screw shaft 631.

Diagnosis system 1 may obtain the index value and the remaining life time using a trained model generated by machine learning. The trained model includes, for example, a classifier using a trained neural network. The trained neural network may include a convolutional neural network (CNN) and a bayesian neural network (BNN). The trained model can be implemented by mounting the trained neural network on an integrated circuit such as an application specific integrated circuit (ASIC) or a field-programmable gate array (FPGA). Diagnosis system 1 may input acquired specification information D1 and actual measurement information D2 to the trained model as input data, calculate the control stability index or the accuracy reduction amount using the information output from the output layer of the trained model, and output the specific state in an identifiable mode.

### CONCLUSION

The following aspects are disclosed based on the exemplary embodiment and the like described above.

Diagnosis system (1) according to a first aspect diagnoses a specific state related to performance of drive system (A1) including mechanical mechanism (M1) driven by motor (62). Diagnosis system (1) includes first acquisition part (11), second acquisition part (12), arithmetic part (21), and output processor (22). First acquisition part (11) acquires specification information (D1) related to a specification of mechanical mechanism (M1). Second acquisition part (12) acquires actual measurement information (D2) related to a mechanical characteristic of mechanical mechanism (M1). Arithmetic part (21) calculates an index value associated with the specific state based on specification information (D1) and actual measurement information (D2). Output processor (22) outputs the index value in a mode in which the specific state can be identified.

According to the aspect described above, the index value calculated based on specification information (D1) and actual measurement information (D2) is output in a mode in which the user can identify the specific state. Thus, diagnosis system (1) has an advantage that the user can easily and intuitively understand the state of drive system (A1).

Regarding diagnosis system (1) according to a second aspect, in the first aspect, mechanical mechanism (M1) is ball screw mechanism (63).

According to the aspect described above, the state of ball screw mechanism (63) can be easily and intuitively understood.

Regarding diagnosis system (1) according to a third aspect, in the second aspect, specification information (D1) includes at least information related to a lead, a screw shaft outer diameter, and a screw total length.

According to the aspect described above, the reliability of the index value related to ball screw mechanism (63) improves.

Regarding diagnosis system (1) according to a fourth aspect, in the second or third aspect, actual measurement information (D2) includes information related to a frequency characteristic of drive system (A1) used to calculate spring constant (Ks) of ball screw mechanism (63).

According to the aspect described above, the reliability of the index value related to ball screw mechanism (63) improves.

Regarding diagnosis system (1) according to a fifth aspect, in any one of the second to fourth aspects, ball screw mechanism (63) includes screw shaft (631) that rotates by receiving power of motor (62), and nut (632) that is coupled to screw shaft (631) via a ball and linearly moves along screw shaft (631) with rotation of screw shaft (631). Actual measurement information (D2) includes information related to a torque applied to nut (632) when the rotation of screw shaft (631) is stopped.

According to the aspect described above, the reliability of the index value related to ball screw mechanism (63) improves.

Regarding diagnosis system (1) according to a sixth aspect, in any one of the first to fifth aspects, the index value indicates at least either control stability that changes according to a change in performance of drive system (A1) or stability of an operation position of drive system (A1) that changes according to a change in performance of the drive system (A1).

According to the aspect described above, the user can more easily and intuitively understand the state of drive system (A1).

Regarding diagnosis system (1) according to a seventh aspect, in any one of the first to sixth aspects, the mode in which the user identifies includes at least one of output of the index value with sound, output of the index value with meter display, output of the index value with color display, and output of the index value with icon display.

According to the aspect described above, the user can more easily understand the state of drive system (A1).

Diagnosis system (1) according to an eighth aspect further includes, in any one of the first to seventh aspects, command generator (23) that generates an operation command for causing drive system (A1) to execute a predetermined test operation. Second acquisition part (12) acquires a test result obtained by the predetermined test operation as actual measurement information (D2).

According to the aspect described above, the reliability of the index value is improved.

Diagnosis system (1) according to a ninth aspect further includes, in the eighth aspect, setting part (24) that performs setting related to an execution timing or an execution frequency of the predetermined test operation according to an operation input from an outside.

According to the above-described aspect, the user's request regarding the execution timing or the execution frequency of the predetermined test operation is easily reflected, and the convenience is improved.

Regarding diagnosis system (1) according to a tenth aspect, in the eighth or ninth aspect, the predetermined test operation includes an operation executed in a speed range in which an overshoot does not occur in drive system (A1).

According to the aspect described above, the reliability of the index value is improved.

Diagnosis system (1) according to an eleventh aspect further includes, in any one of the first to tenth aspects, storage (3) that stores history information (D3) related to the index value. Output processor (22) displays the history of the change in the index value based on history information (D3).

According to the aspect described above, the user can more easily understand the state of drive system (A1).

Diagnosis system (1) according to a twelfth aspect further includes, in the eleventh aspect, prediction part (25). Prediction part (25) generates transition information (D4) indicating the transition of the index value with the lapse of time based on the index value calculated based on actual measurement information (D2) obtained in the latest measurement and history information (D3) stored in storage (3). Prediction part (25) predicts the failure timing of drive system (A1) based on transition information (D4). Output processor (22) outputs a prediction result of prediction part (25).

According to the aspect described above, the user can be notified of the failure timing of drive system (A1) in advance.

A diagnosis method according to a thirteenth aspect diagnoses a specific state related to performance of drive system (A1) including mechanical mechanism (M1) driven by motor (62). The diagnosis method includes a first acquisition processing step, a second acquisition processing step, an arithmetic processing step, and an output processing step. In the first acquisition processing step, specification information (D1) related to the specification of mechanical mechanism (M1) is acquired. In the second acquisition processing step, actual measurement information (D2) related to the mechanical characteristic of mechanical mechanism (M1) is acquired. In the arithmetic processing step, the index value associated with the specific state is calculated based on specification information (D1) and actual measurement information (D2). In the output processing step, the index value is output in a mode in which the user can identify the specific state.

According to the aspect described above, it is possible to provide a diagnosis method that makes it easy for the user to intuitively understand the state of drive system (A1).

A program according to a fourteenth aspect is a program for causing one or more processors to execute the diagnosis method according to the thirteenth aspect.

According to the aspect described above, it is possible to provide a function that makes it easy for the user to intuitively understand the state of drive system (A1).

The configuration according to the second to twelfth aspects is not an essential configuration to diagnosis system (1), and can be omitted as appropriate.

### INDUSTRIAL APPLICABILITY

The diagnosis system, the diagnosis method, and the program according to the present disclosure have an advantage that the state of the drive system can be easily and intuitively understood. Thus, the diagnosis system, the diagnosis method, and the program according to the present disclosure can accurately diagnose a state related to performance of a drive system that is a mechanical mechanism driven by a motor and includes the mechanical mechanism, for example. In this manner, the diagnosis system, the diagnosis method, and the program according to the present disclosure are industrially useful.

### REFERENCE MARKS IN THE DRAWINGS

1 diagnosis system
11 first acquisition part
12 second acquisition part
21 arithmetic part
22 output processor
23 command generator
24 setting part
25 prediction part
3 storage
62 motor
63 ball screw mechanism
631 screw shaft
632 nut
A1 drive system
B1 control system
D1 specification information
D2 actual measurement information
D3 history information
D4 transition information
Ks spring constant
M1 mechanical mechanism

1. A diagnosis system that diagnoses a specific state related to performance of a drive system including a mechanical mechanism driven by a motor, the diagnosis system comprising:
a first acquisition part that acquires specification information related to a specification of the mechanical mechanism;
a second acquisition part that acquires actual measurement information related to a mechanical characteristic of the mechanical mechanism;
an arithmetic part that calculates an index value associated with the specific state based on the specification information and the actual measurement information; and
an output processor that outputs the index value in a mode in which a user identifies the specific state.

2. The diagnosis system according to claim 1, wherein the mechanical mechanism is a ball screw mechanism.

3. The diagnosis system according to claim 2, wherein the specification information includes at least information related to a lead, a screw shaft outer diameter, and a screw total length.

4. The diagnosis system according to claim 2 or 3, wherein the actual measurement information includes information related to a frequency characteristic of the drive system used to calculate a spring constant of the ball screw mechanism.

5. The diagnosis system according to any one of claims 2 to 4, wherein
the ball screw mechanism includes a screw shaft that rotates by receiving power of the motor and a nut that is coupled to the screw shaft via a ball and linearly moves along the screw shaft with rotation of the screw shaft, and
the actual measurement information includes information related to a torque applied to the nut when the rotation of the screw shaft is stopped.

6. The diagnosis system according to any one of claims 1 to 5, wherein the index value indicates at least either control stability that changes according to a change in performance of the drive system or stability of an operation position of the drive system that changes according to a change in performance of the drive system.

7. The diagnosis system according to any one of claims 1 to 6, wherein the mode in which the user identifies includes at least one of output of the index value with sound, output of the index value with meter display, output of the index value with color display, and output of the index value with icon display.

8. The diagnosis system according to any one of claims 1 to 7, the diagnosis system further comprising a command generator that generates an operation command for causing the drive system to execute a predetermined test operation,
wherein the second acquisition part acquires a test result obtained in the predetermined test operation as the actual measurement information.

9. The diagnosis system according to claim 8, the diagnosis system further comprising a setting part that performs setting related to an execution timing or an execution frequency of the predetermined test operation according to an operation input from an outside.

10. The diagnosis system according to claim 8 or 9, wherein the predetermined test operation includes an operation executed in a speed range in which an overshoot does not occur in the drive system.

11. The diagnosis system according to any one of claims 1 to 10, the diagnosis system further comprising a storage that stores history information related to the index value,
wherein the output processor displays a history of a change in the index value based on the history information.

12. The diagnosis system according to claim 11, the diagnosis system further comprising a prediction part that generates transition information indicating a transition of the index value with a lapse of time based on the index value calculated based on the actual measurement information obtained in a latest measurement and the history information stored in the storage, and predicts a failure timing of the drive system based on the transition information,
wherein the output processor outputs a prediction result of the prediction part.

13. A diagnosis method that diagnoses a specific state related to performance of a drive system including a mechanical mechanism driven by a motor, the diagnosis method comprising:
a first acquisition processing step of acquiring specification information related to a specification of the mechanical mechanism;
a second acquisition processing step of acquiring actual measurement information related to a mechanical characteristic of the mechanical mechanism;
an arithmetic processing step of calculating an index value associated with the specific state based on the specification information and the actual measurement information; and
an output processing step of outputting the index value in a mode in which a user identifies the specific state.

14. A program for causing one or more processors to execute the diagnosis method according to claim 13.
